(19) United States
(12) Patent Application Publication
(10) Pub. No.: US 2013/0207000 A1
(43) Pub. Date: Aug. 15, 2013

(54) Laser-Ablation Ion Source with Ion Funnel

(71) Applicants: Detlef Günther, Zurich (CH); Bodo Hattendordf, Zurich (CH); Rolf Dietiker, Huntwangen (CH); Tatiana Egorova, Zurich (CH); Victor Varentsov, Darmstadt (DE)

(72) Inventors: Detlef Günther, Zurich (CH); Bodo Hattendordf, Zurich (CH); Rolf Dietiker, Huntwangen (CH); Tatiana Egorova, Zurich (CH); Victor Varentsov, Darmstadt (DE)

(73) Assignee: ETH ZURICH, Zurich (CH)

(21) Appl. No.: 13/808,135

(22) PCT Filed: Jul. 1, 2011
(86) PCT No.: PCT/EP2011/003256

§ 371 Date: Mar. 22, 2013

(30) Foreign Application Priority Data
Jul. 6, 2010 (EP) 10006940.0

(51) Int. Cl. H01J 27/24; H01J 27/02

(52) U.S. Cl. CPC H01J 27/24; H01J 27/024
USPC 250/396 R

(57) ABSTRACT

A laser-ablation ion source for generating a low energy ion beam having low longitudinal and transverse emittance, including a supersonic nozzle, followed by an RF ion funnel. A laser source generates a laser beam which is focused by a lens to an ablation site. The ablation site is located upstream of the nozzle, at a distance of less than 10 mm from the nozzle aperture. The laser irradiates the ablation site through the nozzle aperture to generate the ions.

### TECHNICAL FIELD

The present invention relates to an ion source wherein ions are generated by ablation or desorption from a solid target by a laser beam in the presence of a buffer gas flow and transported with the buffer gas into an ion funnel before entering a high vacuum region for further manipulation of the ion beam. The invention further relates to an ion funnel which is adapted to be used in such an ion source, and to a method of producing an ion beam employing a nozzle and an ion funnel for focusing the resulting low energy ion beam into a high vacuum region.

### PRIOR ART

In many applications an ion source capable of providing a well-defined ion beam having a low ion energy spread (corresponding to a low emittance) and high ion current is required. Such applications include, e.g. mass spectrometry and different micro- and nanostructuring technologies, for example in microchip production and modification.

Several different approaches have been suggested in the prior art to tackle the problem of ion energy spread after initial ionization.

In a first group of approaches, the ions are accelerated to kinetic energies of several keV or even MeV, which reduces the relative energy spread. Since the ion beam still carries the initial conditions as after initial ionization, any subsequent deceleration inside a high vacuum region, e.g. for mass spectrometry applications, would lead to an increase of the energy spread and thus widen the beam accordingly, which either reduces the number of ions that can pass through a fixed entrance aperture before the mass spectrometer or increase the image of the beam in ion deposition/lithography. In addition, high acceleration voltages increase the complexity of the instrument due to the need of specific power supplies and respective electric insulation. Furthermore, high voltages cannot be applied in all pressure regimes due to potential breakdown, and high-energy ions can be problematic with respect to damage of the surface of either the substrates subjected to the ion beam or of any apertures along the ion path.

Other approaches that were introduced in mass spectrometry applications involve the use of a collision cell arrangement, wherein the ions are thermalized inside a pressurized cell, usually equipped with radiofrequency multipole ion guides or ion traps to confine the ion beam at the cell axis. Problematic here can be the fact that these collision cells are usually located relatively far downstream from the location of initial ionization, requiring ion optical guidance of the ion beam before it enters the collision cell. This may reduce the overall transmission and thus the attainable ion flux.

Recently, it has been suggested to employ ion funnel-based transfer devices in electrospray ionization (ESI) mass spectrometry. Different embodiments of ion funnels are disclosed, e.g., in U.S. Pat. No. 6,107,628. In some embodiments, the funnel comprises a plurality of stacked electrodes having consecutively smaller apertures. In other embodiments, two staggered helical coils whose diameter decreases along their length are employed. A buffer gas carrying the ions is injected into the wide end of the ion funnel. RF voltages are applied to the electrodes or coils to create a quasi-stationary potential well in the radial direction, to repel ions from entering the space between the electrodes, while the buffer gas is pumped away. In this manner, the ion beam may be significantly narrowed while a high transmission is achieved, i.e. the density of the ion flux in the beam is effectively increased. At the same time, the energy spread of the ions is significantly reduced by collisional cooling with the buffer gas. Optionally, depending on the design of the ion funnel, a DC potential gradient may additionally be applied along the length of the ion funnel for accelerating the ions.

Various embodiments of ion sources employing ion funnels are also described in U.S. Pat. No. 6,967,325, U.S. Pat. No. 7,064,321 and U.S. Pat. No. 7,351,964.

US 2002/01856606 discloses an ESI ion source employing an ion funnel. The ion funnel comprises a plurality of rectangular electrodes separated by insulating Teflon™ spacers. All electrodes have the same orientation and are connected individually to a voltage source which supplies the electrodes with both an AC voltage and a DC voltage gradient. The need of electrical insulation for each electrode makes setup of this ion funnel relatively complicated.

In RU 2 353 017 it has been suggested to employ an ion funnel in the context of ion generation by laser ablation. A buffer gas expands into the low pressure region of an axially symmetric converging-diverging supersonic nozzle. A tube extends from the nozzle stagnation chamber through the throat of this nozzle into its diverging part. A wire- or rod-shaped target is passed through the inner tube inside the nozzle and positioned in the diverging supersonic part of the nozzle. A buffer gas is passed through the annular nozzle throat, reaching supersonic conditions in the diverging part of the nozzle. A laser beam is focused onto the target end to generate ions from the target by ablation. The ions are carried by the supersonic buffer gas stream and thermalized by collisions with the buffer gas atoms/molecules while being transported by the buffer gas flow into a ion funnel mounted downstream of the nozzle on the nozzle axis. Here the ion beam is focused while a large proportion of the buffer gas is removed by pumping.

While this kind of ion source can provide an excellent ion beam quality, the fact that the target must be positioned through a tube traversing the nozzle aperture severely limits the usefulness of this design. In particular, target geometry is restricted quite significantly by this design, and target changes may prove to be time-consuming. In addition, in this kind of ion source, ablation occurs in the low pressure region of the supersonic buffer gas jet, requiring relatively large gas consumption to ensure effective thermalization of the ions and accordingly larger pumping capacity to maintain optimum vacuum conditions.

US 2002/0175278 discloses various MALDI ion sources. In one embodiment, an ion funnel is employed. The sample is placed on a rotatable table which extends into a region downstream of an entry opening of the ion funnel. Ablation is carried out downstream of the entry opening. The device is operated at atmospheric pressure.

### SUMMARY OF THE INVENTION

In a first aspect, it is an object of the present invention to provide an ion source employing laser ablation/desorption in connection with an ion funnel in which target placement and target changes are simplified. It is a further object of the present invention to provide an ion source employing laser ablation/desorption in connection with an ion funnel that is capable of achieving a low ion beam emittance with comparatively small gas consumption and thus moderate pumping requirements.

Each of these objects is achieved by an ion source having the features of claim 1. Further embodiments of the invention are laid down in the dependent claims.

In a second aspect, it is a further object of the invention to provide an ion funnel which may be manufactured easily and cost-effectively. This object is achieved by an ion funnel having the features of claim 7.

In a third aspect, the present invention provides a method of producing an ion beam, the method having the features of claim 14.

Thus, in a first aspect, the present invention provides an ion source comprising:
a nozzle having a nozzle aperture, the nozzle defining a longitudinal axis;
an ion funnel positioned downstream of said nozzle aperture and arranged coaxially with said nozzle aperture on said longitudinal axis;
a target holder for receiving a target having a target surface; and
a laser source for generating an ablation laser beam.

The target holder and the laser source are arranged in a manner that said laser beam impinges upon the target surface of a target received by the target holder at an ablation site located upstream of said nozzle aperture, at a distance of less than 10 mm from said nozzle aperture.

In this manner, target changes are much simplified. Targets of an almost arbitrary geometry may be used. If the target is placed on an x-y translation stage, it is even possible to raster the laser beam over the target surface by moving the target with respect to the laser beam for example to obtain spatially resolved mass spectra, or to use a sample plate containing a plurality of targets in different positions and to move the sample plate so that the different targets are consecutively hit by the laser beam. Since the size of the nozzle aperture may be chosen without being limited by a tube passing through the nozzle aperture as in the above-discussed prior-art solution, gas flow may be significantly reduced.

An additional advantage of the presently proposed arrangement of the target in front of the nozzle is that the ions are rapidly cooled by collisions with the buffer gas already before entering the nozzle, at a relatively high buffer gas pressure. This allows operating the ion source at comparably low buffer gas flow rates and therefore using smaller vacuum pumps.

The nozzle is preferably a convergent-divergent (CD) supersonic nozzle. A CD nozzle is a tube that is pinched in the middle, resulting in a generally asymmetric hourglass-shape with a converging entrance cone and a diverging exit cone meeting at the “throat” of the nozzle (at the position of its minimum cross sectional area). A CD nozzle may be used to accelerate a gas passing through it to supersonic speed and to shape the exhaust flow so that the thermal energy is converted into directed kinetic energy. Generally, for CD nozzles it is preferred that the entrance cone (often called the “subsonic cone”) is steeper and shorter (i.e., has a larger cone angle) than the exit cone (often called the “supersonic cone”), the cone angle of the entrance cone being at least 1.5 times the cone angle of the exit cone. Typical dimensions for conical CD nozzles that may advantageously be employed in the context of the present invention are as follows:
half angle of entrance cone: 30-45°
half angle of exit cone: 15-40°
minimum diameter (“throat diameter”): 0.2-2 mm
entrance and exit diameter: 2-10 mm
entrance cone length (measured along longitudinal axis): 0.5-5 mm
exit cone length (measured along longitudinal axis): 2-20 mm

However, the invention is not limited to this size range.

The term “nozzle aperture” is generally to be understood as relating to that part of the nozzle opening where the cross sectional area of the opening is the smallest. In the case of a CD nozzle, the aperture is the “throat” of the nozzle.

The target surface, in particular, the ablation site, is located at a distance of less than 10 mm, preferably between 0.2 mm and 5 mm, more preferably less than 3 mm, from the nozzle aperture, upstream of the aperture. Preferably, the target surface, in particular, the ablation site, is located at a distance from an entrance plane of the nozzle. Such an arrangement provides the least restrictions to target geometry. In this case, the distance to the entrance plane is preferably larger than 0 mm and less than 5 mm. In any case, it is preferred that the ablation site is arranged coaxially with the nozzle aperture and the ion funnel on the longitudinal axis.

In an advantageous embodiment, the laser beam is directed at the target surface along the longitudinal axis. This avoids complicated mechanical and optical installations, e.g. additional lenses and mirrors, which are necessary when the laser is directed to the target at an angle. In a preferred embodiment, the laser source (including any laser optical components) is arranged to irradiate the ablation laser beam onto the ablation site substantially along the longitudinal axis and through the nozzle aperture. It is particularly preferred that the laser beam passes not only through the nozzle aperture, but also through the ion funnel along the longitudinal axis. This task is much simplified if ion optical components are provided downstream of the ion funnel to deflect the ion beam to a direction that is angled, preferably orthogonal, to the longitudinal direction. In this manner, the laser beam can be coupled into the ion funnel coaxially with the ion funnel without significantly interfering with the ion beam. In an alternative embodiment, the laser can be directed to a target positioned at the front of a transparent target holder by irradiation from the opposite side.

Regardless of the direction in which the laser beam irradiates the target, it is preferred that the laser source comprises one or more optical components, such as one or more lenses, for focusing the laser beam to the ablation site.

In practice, ion sources of the present invention will often further comprise one or more of the following components:
a sample chamber adapted to receive the buffer gas or a gas mixture at a first pressure, the sample chamber housing the target, in particular, the target ablation site; and
an expansion chamber adapted to be pumped to a second pressure substantially lower than said first pressure, the expansion chamber housing the ion funnel.

The nozzle aperture then connects the sample chamber and the expansion chamber so as to allow a flow of said buffer gas from the sample chamber to the expansion chamber through the nozzle aperture on account of the pressure difference between the sample chamber and the expansion chamber. On account of the lower pressure in the expansion chamber, a large proportion of the buffer gas will be removed laterally, through gaps between the electrodes of the ion funnel, from the beam entering the expansion chamber, while the ions carried by the buffer gas remain radially confined by the ion funnel. Preferably the pressure differential between the sample chamber and the expansion chamber is chosen such that supersonic conditions are reached in the nozzle. It is to be understood that the pressure does not have to be uniform across the sample chamber or across the expansion chamber. All that matters is that the pressure in the sample chamber at the nozzle entrance is generally higher than the pressure in the expansion chamber at the nozzle exit. Typical pressure values in the sample chamber are 10 to 1000 mbar, while typical pressures in the expansion chamber are 0.1 to 10 mbar.

The expansion chamber may be followed by a high-vacuum chamber. The high-vacuum chamber is adapted to be maintained at a third pressure substantially lower than said second pressure, in particular, at a pressure below 10⁻² mbar. An exit aperture aligned coaxially with the nozzle aperture and with the ion funnel then connects the expansion chamber and the high-vacuum chamber. The exit aperture preferably has a diameter of less than 2 mm, more preferably less than 1 mm to minimize the buffer gas load into the high-vacuum chamber. The high-vacuum chamber may house ion optical components for deflecting an ion beam exiting the exit aperture into a direction that is angled, in particular, transverse, to the longitudinal axis.

If the laser beam is passed along the longitudinal axis, through the ion funnel, as described above, the laser beam may be coupled into the expansion chamber through a suitable window arranged in a wall of the high-vacuum chamber on the longitudinal axis downstream of the exit aperture of the ion funnel. The laser beam will then pass through said window, through the exit aperture of the ion funnel and the nozzle aperture.

The term “ion funnel” is to be understood as encompassing any arrangement of a plurality of electrodes, each electrode defining an aperture, wherein the electrode arrangement is capable of generating a radially confining pseudo-potential that will narrow an ion beam entering the ion funnel axially at its upstream end and travelling along the axis of the ion funnel towards its downstream end when RF voltages are applied to the electrodes with identical amplitude and frequency, but different phases. Explicit reference is made to U.S. Pat. No. 6,107,628, U.S. Pat. No. 7,064,321 and U.S. Pat. No. 7,351,964, whose contents are incorporated herein by reference, for teaching ion funnels suitable to be used in the context of the present invention.

In particular, an ion funnel may comprise at least three, preferably at least three usually at least ten electrically conducting electrodes arranged along a longitudinal axis, each electrode having an aperture, the apertures of the electrodes being coaxially arranged in a spaced relationship along the longitudinal axis, at least one selected electrode aperture (the “conduction limiting aperture”) being smaller than at least one other electrode aperture upstream of the selected electrode. Preferably, the ion funnel comprises at least three, more preferably at least five electrodes whose apertures decrease continuously along the length of the funnel towards the downstream end.

The electrodes, by the way of example, may take the form of circular rings, wherein the inner diameter of the rings defines the apertures, or of flat sheets or plates of metal with circular cutouts, wherein the cutouts define the apertures. More specific examples will be described below. However, the shape of the apertures is not limited to circular forms and may take any other shape, and the shape may even vary along the length of the ion funnel. Usually the first aperture (the entrance aperture of the funnel) will be the largest aperture, and the last aperture (the exit aperture) will be the smallest aperture; however, this is not necessarily the case, and modified ion funnels have been suggested in the prior art, e.g., to minimize fringe-field effects at the ends of the ion funnel. Ion sources with such modified ion funnels shall also be encompassed by the present invention. For examples of such designs, explicit reference is made to U.S. Pat. No. 7,351,964, already referred to above.

In addition to the ion funnel itself, the ion source may further comprise an RF voltage source operable to supply the electrodes of the ion funnel with RF voltages. The RF voltage source is then operable to provide the RF voltages to the electrodes of the ion funnel with equal frequency and equal or variable amplitudes and with at least two different phases such that the overall RF phase alternates at least once, preferably several times, along the length of the ion funnel. In particular, the RF voltages are applied in a manner that adjacent electrodes are out of phase with one another, preferably by between 90° and 270°, most preferably by 180°. The frequency of the RF voltage is preferably in the range of 100 kHz to 100 MHz, its amplitude in the range of 1 V to 500 V.

In some embodiments, DC voltages may be applied between electrodes in addition to the RF voltage to provide one or more electric field gradients accelerating the ions along the length of the ion funnel. Suitable arrangements for supplying such DC voltages to the electrodes are known from the prior art. However, it is preferred in the context of the present invention to provide only AC voltages to the electrodes. This is possible because the ions are transported through the ion funnel by the buffer gas stream. Omitting a DC voltage component considerably simplifies construction and electrical connection of the ion funnel. In particular, in a simple embodiment, two staggered sets of electrodes may be formed, wherein the electrodes of each set are directly electrically connected, and wherein the sets are supplied with RF voltages of only two opposite phases.

Even if no DC gradient is applied along the length of the funnel between the funnel electrodes, it is preferred to apply a negative DC potential offset (which is defined by the DC component of the time-averaged potential at the funnel electrodes) between the funnel electrodes and the nozzle. This offset is preferably in the range of 1-10 V, more preferably in the range 1-5 V. In this way, the influence of electrons entering the funnel can be effectively suppressed.

In a second aspect, the present invention provides an improved type of ion funnel. The ion funnel according to the present invention comprises a plurality of electrically conducting electrodes spaced along a longitudinal axis, each electrode having an electrode aperture, the electrode apertures being coaxially arranged on the longitudinal axis. The electrodes are shaped as substantially flat, elongate plates, the long axis of each electrode defining an electrode axis. The electrode axes are oriented perpendicular to the longitudinal axis. In order to render the electrodes readily accessible (e.g., for establishing electrical connections), the electrode axes of adjacent electrodes are chosen to have different orientations around the longitudinal axis.

In particular, the elongate shape of the electrodes enables an arrangement wherein the electrodes are grouped in two or more stacks, wherein the electrodes of each stack have identical orientations, wherein the orientations of the stacks are different, in particular, perpendicular, and wherein the stacks are staggered along the longitudinal axis such that electrodes from different stacks alternate along the longitudinal axis. In other words, in such an arrangement a first group of electrodes are arranged such that their electrode axes have a first orientation around the longitudinal axis, a second group of electrodes are arranged such that their electrode axes have a second orientation around the longitudinal axis that is different from the first orientation, and the groups are arranged such that electrodes of the first and second group (and possibly any further groups) alternate along the longitudinal axis. If there are exactly two such groups, it is preferred that their orientations differ by 90°, i.e., that they are arranged perpendicularly (crosswise) to each other.

The electrodes may be held in place by supporting rods extending parallel to the longitudinal axis. In particular, the electrodes of the first group may be supported by at least one first supporting rod (preferably two such first rods symmetrically arranged on diametrically opposite sides of the longitudinal axis), and the electrodes of the second group may be supported by at least one second supporting rod (preferably two such second rods symmetrically arranged on diametrically opposite sides of the longitudinal axis). The first and second supporting rods then extend parallel to the longitudinal axis at different angular positions around the longitudinal axis. In particular, in the case of exactly two groups of electrodes, the supporting rods are preferably arranged at angular positions spaced by 90° around the longitudinal axis.

In a preferred embodiment, the electrode aperture is disposed in the center of each electrode, and the electrodes are arranged substantially symmetrically around the longitudinal axis. In somewhat more general terms, each electrode may have first and second wings extending away from the longitudinal axis along the electrode axis in opposite directions. Then each electrode of the first group and each electrode is preferably supported by two supporting rods symmetrically arranged on diametrically opposite sides of the longitudinal axis, each supporting rod being attached to one wing of each electrode.

The electrodes of each group are preferably electrically connected to each other by one or more electrically conducting elements, in particular, by one or more low-ohmic (preferably metallic) conductors arranged to ensure that all electrodes of each group essentially have the same RF phase when fed with an RF voltage.

The ion funnel may be complemented by an RF voltage source, as principally already described above, for providing a first RF voltage to the first group of electrodes and a second RF voltage to the second group of electrodes, the second RF voltage having identical frequency and amplitude as the first RF voltage, but being out of phase with the first RF voltage. If there are two groups of electrodes, the first and second RF voltages are preferably out of phase by 180°, i.e., the two groups of electrodes may be connected to the two terminals of a single RF power supply, the terminals having opposite polarity.

If three or more staggered groups of electrodes with identical orientation are provided, the orientations of these groups are preferably distributed evenly around the longitudinal axis. The electrodes of each group are again preferably electrically connected. The groups are then preferably fed by RF voltages having identical amplitude and frequency, but phases differing by 360°/N, where N is the number of groups of electrodes.

The ion funnel according to the second aspect of the invention, as described above and as described by the way of example further below, may advantageously be employed in the ion source according to the first aspect of the present invention. However, application of such an ion funnel is not limited to specific ion sources such as laser-ablation ion sources, and the ion funnel may also be employed in other types of ion sources, e.g., in electrospray, thermospray or discharge ionization sources or in any other application where ions are to be captured and focused.

In a third aspect, a method of producing an ion beam is provided, comprising:
ablating ions from a target surface at an ablation site by an ablation laser beam;
transporting said ions by a stream of buffer gas through a nozzle defining a nozzle aperture; and
transporting said ions, together with said buffer gas, into an ion funnel located downstream of said nozzle and coaxially with said nozzle aperture on a longitudinal axis;

According to the invention, the ablation site is located upstream of the nozzle aperture, at a distance of less than 10 mm from said nozzle aperture.

In particular, the method may employ an ion source according to the first aspect of the invention, and/or may employ an ion funnel according to the second aspect of the present invention. The above considerations concerning the geometry of the target and of the nozzle, as well as the above considerations concerning the setup of the ion funnel, likewise also apply to the instant method. In particular, it is preferred that the ablation laser beam irradiates the beam spot location substantially along the longitudinal axis, and in this case preferably through the nozzle opening.

In the present context, the term “laser ablation” is to be understood to encompass any method in which a solid target is irradiated by laser light to cause ions to be formed from the target material. This includes methods commonly known as laser desorption and ionization (LDI) and matrix-assisted laser desorption and ionization (MALDI), as they are generally well-known in the art.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematic sketch of an ion source in accordance with the present invention;

FIG. 2 shows an enlarged sketch of portions containing the nozzle and ion funnel;

FIG. 3 shows a schematic plan view of two electrodes of the ion funnel in the plane III-III;

FIG. 4 shows a schematic plan view of the end plate in the plane IV-IV;

FIG. 5 shows a diagram illustrating the simulated gas velocity (part A) and gas pressure (part B) as a function of longitudinal position along the axis of the ion source; in part (C), the nozzle and ion funnel are schematically illustrated for comparison;

FIG. 6 shows the simulated longitudinal ion velocity distribution at the exit of the ion source, after acceleration by 10 Volts, for several m/z ratios;

FIG. 7 shows the simulated radial ion velocity distribution at the exit of the ion source, after acceleration by 10 Volts, for several m/z ratios;

FIG. 8 shows the dependence of the current measured downstream the ion funnel with increasing RF amplitude applied to the funnel electrodes;

FIG. 9 shows the effect of the potential bias of the ion funnel electrodes on net ion current recorded downstream the funnel exit; and

FIG. 10 shows the transient signal for the current measured at an electrode downstream the ion funnel exit at different funnel bias settings.

### DESCRIPTION OF PREFERRED EMBODIMENTS

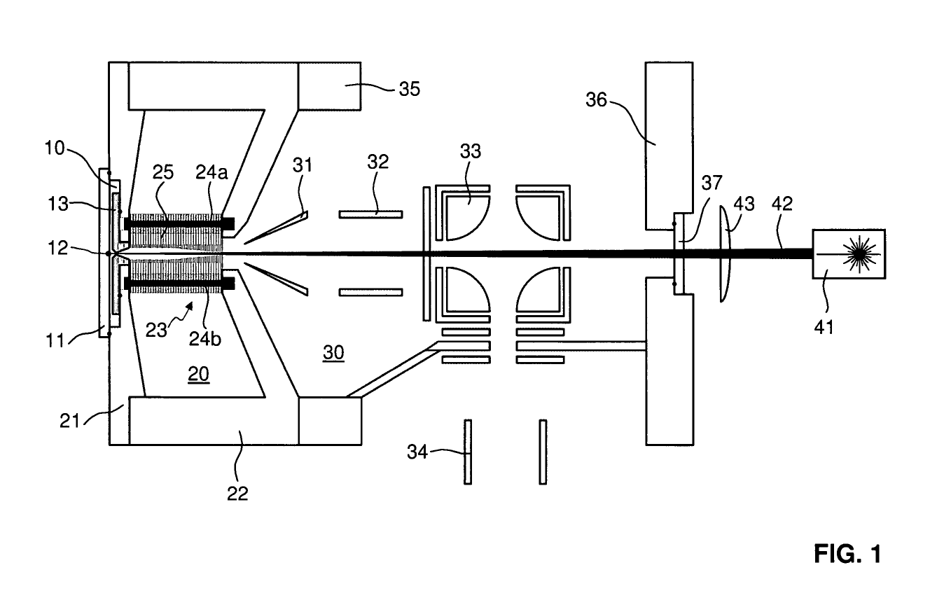

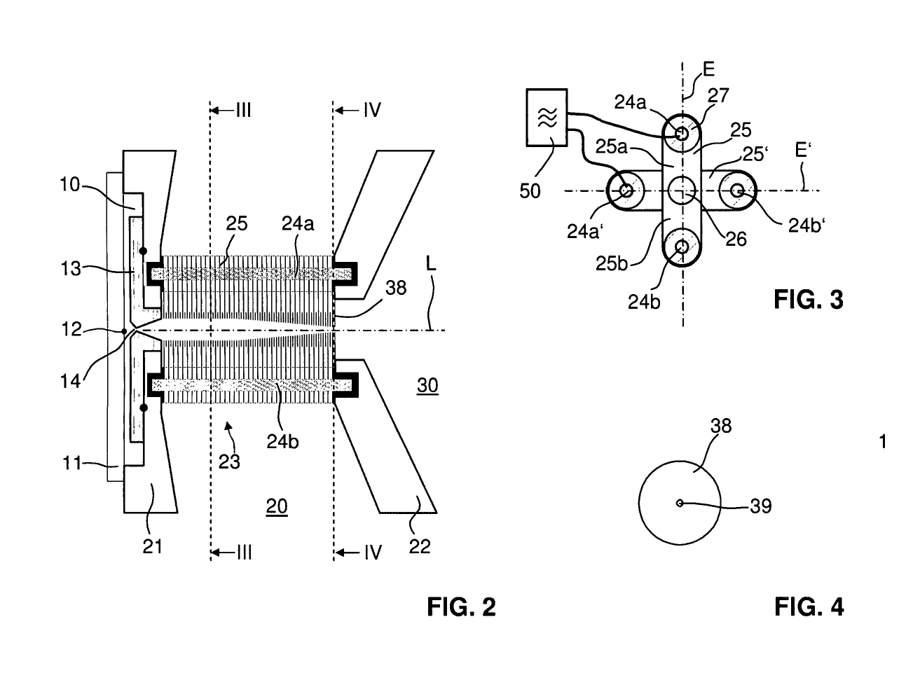

An ion source constructed in accordance with the present invention is schematically illustrated in FIGS. 1 and 2. The ion source comprises a sample chamber 10, an expansion chamber 20, and a high-vacuum chamber 30.

The sample chamber 10 is delimited by a front plate 21 having a disk-shaped central depression and defining a comparatively large, circular central opening. The central depression is covered by a plate-like target holder 11 which here is also disk-shaped. A gas inlet (not shown in the Figures) for a buffer gas is provided in the front plate or in the target holder.

The target is mounted to the target holder at an ablation site 12. In the simplest case, the target may take the form of a spot of a dried sample solution on the surface of the generally flat target holder, which may simply be a disk-shaped substrate, e.g. made of stainless steel. Alternatively, in the case of a massive, solid target, the target may be directly mounted to the front plate 21 in place of the target holder 11. In this case, the front plate 21 acts as a target holder. Of course, many other types of target holders or substrates may be employed, as they are generally known in the art, including target holders or substrates mounted on an x-y translation stage which allows the target to be moved within the sample chamber.

A nozzle 13 having a disk-shaped mounting flange is sealingly mounted in the central opening of the front plate 21. The nozzle 13 is a converging-diverging (CD) nozzle acting as a supersonic nozzle, having a “subsonic” entrance cone and a “supersonic” exit cone. The nozzle defines with its nozzle axis a longitudinal axis L. In the present example, the nozzle has the following dimensions:
Half angle of subsonic cone: 45°
Half angle of supersonic cone: 26.6°
Throat diameter: 0.5 mm
Exit diameter: 4.5 mm
Subsonic cone length: 1.0 mm
Supersonic cone length: 4.0 mm

The nozzle defines, with its front surface, a flat entrance plane. The ablation site of the target is placed at a distance of 1.0 mm from the entrance plane, on the longitudinal axis L. Expressed differently, the target is placed at a distance of 2.0 mm from the throat (aperture) of the nozzle and coaxially with the nozzle.

An ion funnel 23 is held between a housing 22 of the expansion chamber 20 and the front plate 21. An opening (not shown) for connecting a vacuum pump is provided in the side wall of the housing 22, and a vacuum pump (not shown) is connected to this opening to produce a vacuum in the expansion chamber 20 and to remove buffer gas entering through the nozzle 13 into the expansion chamber 20.

The ion funnel 23 comprises a plurality of electrodes stacked along the longitudinal axis with gaps between them, supported by supporting rods extending parallel to the longitudinal axis L at a distance to the axis. With one end, each supporting rod is tightly pressed into an electrically insulating bushing held in a blind hole of the housing 22. The other end is pushed into an electrically insulated bushing held in a through hole of the front plate 21, with some axial play.

In the present example, 74 electrodes are employed. The arrangement of electrodes is illustrated in more detail in FIG. 3. The electrodes 25, 25′ are shaped as flat, elongate plates with rounded ends, each plate defining, by its long axis, an electrode axis E, E′. Each electrode has a central aperture 26, the apertures of all electrodes being centered on the longitudinal axis L. The size of the apertures 26 decreases continuously along the length of the ion funnel.

Two groups of electrodes are staggered into each other. The first group is formed by electrodes 25 that are oriented vertically, while the second group is formed by electrodes 25′ that are oriented horizontally. This results in a cross-shaped arrangement of electrodes 25, 25′ in a plan view, as apparent from FIG. 3.

Each electrode 25 of the first group may be understood to have two wings 25a, 25b pointing radially into opposite directions. Each of these wings has an axial through-opening near its end. A supporting rod 24a, 24b is passed through each of these openings. Sleeve-shaped spacers 27 are mounted in the supporting rods between electrodes to regularly space the electrodes along the longitudinal axis. These spacers are metallic and electrically conducting, thereby electrically connecting all electrodes 25 of the first group with each other. Likewise also the electrodes 25′ of the second group have symmetric wings with supporting rods 24a′, 24b′ passing through these wings, and are likewise spaced by metallic spacers. Thereby also the electrodes 25′ of the second group are directly electrically connected to each other. Each group of electrodes is connected to an opposite phase of an RF generator 50, which is operable to supply RF voltages of equal amplitude and frequency, but opposite polarity to the two groups of electrodes. No DC component is required.

The supporting rods 24a, 24a′, 24b, 24b′ are evenly distributed around the longitudinal axis at angular intervals of 90°.

An end plate 38, shown in FIG. 4, is mounted at the end of the ion funnel, separating the expansion chamber 20 from the high-vacuum chamber 30, and defining an exit aperture 39.

In the present example, the ion funnel has dimensions as follows:
74 electrodes, length 25.1 mm, width 6.5 mm, thickness 0.1 mm;
4 supporting rods, length 34 mm, diameter 2.0 mm;
center distance between supporting rods: 18.5 mm;
central aperture of electrodes: 4.5 mm for the first 30 electrodes, then linearly decreasing to 0.9 mm;
spacer thickness: 0.7 mm
overall length of ion funnel: 29.5 mm
end plate: diameter 14 mm, thickness 0.1 mm, aperture 0.9 mm.

The high-vacuum chamber 30 is delimited by a housing 35, 36. To the top in FIG. 1, a high-vacuum pump (not shown) is connected to the high-vacuum chamber. To the bottom in FIG. 1, a device receiving the ion beam generated by the ion source may be mounted, e.g., a mass spectrometer. Ion optical components 31, 32, 33, 34, which are shown only in a highly schematic fashion, are mounted in the high-vacuum chamber, as generally known in the art. In particular, the ion optical components act to deflect an ion beam entering the high-vacuum chamber 30 through the exit aperture 39 into a direction perpendicular to the longitudinal axis L (i.e., to the bottom in FIG. 1). Such ion optical components are generally well known in the art.

A pulsed laser 41 generates a laser beam 42, which is passed through a focusing lens 43 mounted on the longitudinal axis and through a transparent window 37 in the housing of the high-vacuum chamber. The laser beam passes through the ion funnel 23 and through the nozzle 13 on the longitudinal axis and hits the target mounted on the target holder 11 at the ablation site 12. The lens 43 is positioned such that the laser beam is focused to the ablation site 12 to provide an energy density sufficient for ablation or desorption and ionization at this site. In other words, the ablation site 12 is placed in or next to the focus of the laser beam 42.

In operation, a target is placed at the ablation site 12. A buffer gas or a mixture containing defined amounts of a reactive gas is admitted into the sample chamber 10 and passes through the nozzle 13, forming an axial gas stream or jet entering the expansion chamber 20. The laser 41 is operated to generate ions from the target surface by ablation. These ions and ions formed after ion-molecule reactions, when a reactive gas is employed, are transported by the gas stream into the ion funnel in the expansion chamber 20. The lower pressure in the expansion chamber is maintained by a vacuum pump of suitable pumping capacity. An RF voltage is applied to the ion funnel to radially confine the ions in the ion funnel, while a major proportion of the buffer gas is removed radially through the gaps between the electrodes 25, 25′ due to the pressure gradient between the region inside the ion funnel and the outer part of the expansion chamber. The ion beam, largely cleaned of the buffer gas, exits the expansion chamber through the exit aperture 39 and is deflected by the ion optical components 31-34 in the high-vacuum chamber.

In the present example, the pressure in the expansion chamber 20 may be chosen in the region around 1 mbar, while the pressure in the sample chamber 10 may be chosen in the region around 100 mbar. However, other pressure levels may be chosen for other geometries of the nozzle 13 and the ion funnel 23.

It is to be understood that the buffer gas pressure will of course not be uniform everywhere in the sample chamber and in the expansion chamber, respectively. In particular, the gas pressure will be higher along the axis of the ion funnel than outside of the ion funnel, due to the buffer gas stream entering the expansion chamber through the nozzle 13. However, as will become apparent below, the buffer gas pressure in the expansion chamber 20 is generally much lower than in the sample chamber despite this non-uniform distribution.

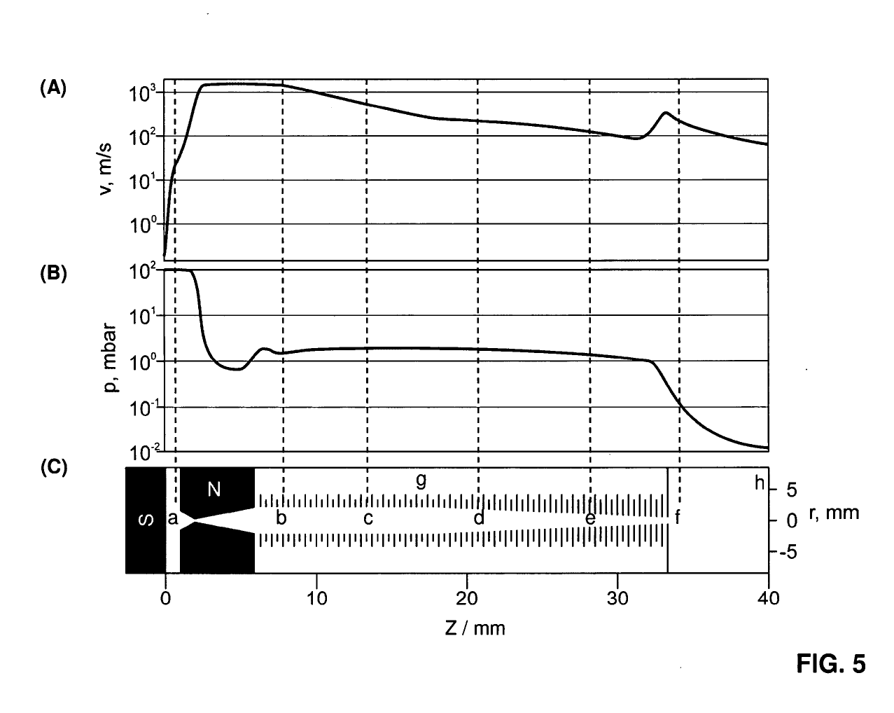

FIGS. 5-7 show results of numerical simulations for an ion source as described above, illustrating the effectiveness of such an ion source in providing a well-defined ion beam of low axial and radial emittance. It was assumed that the ion funnel is operated at a frequency of 5 MHz and an RF amplitude of 7.5 Volts.

In particular, FIG. 5 illustrates the axial gas velocity v (A) and the gas pressure (B) as a function of the axial position within the ion source (i.e. of the distance Z from the ablation site), at a radial position r=0 from the longitudinal axis. Part (C) of FIG. 5 illustrates the corresponding positions in the ion source. The target is denoted by the reference sign S, while the nozzle is denoted by reference sign N. Selected calculated pressure and velocity values at positions a-h as shown in part (C) of FIG. 5 are given in Table 1; numbers which were supplied as boundary conditions for the simulations are marked by an asterisk (*).

TABLE 1
Gas velocity and pressure as a function of position.

| Position | v (m/s) | p (mbar) |
|---|---|---|
| a | 30 | 100* |
| b | 1080 | 1.63 |
| c | 490 | 1.83 |
| d | 204 | 1.73 |
| e | 130 | 1.46 |
| f | 170 | 0.13 |
| g | 3 | 0.99* |
| h | 3 | 10⁻⁴* |

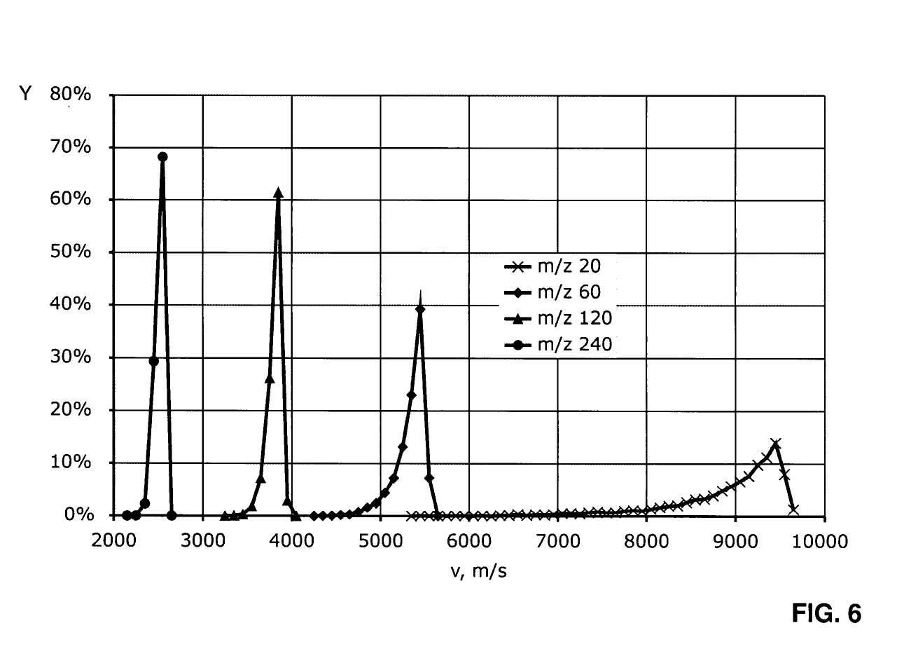

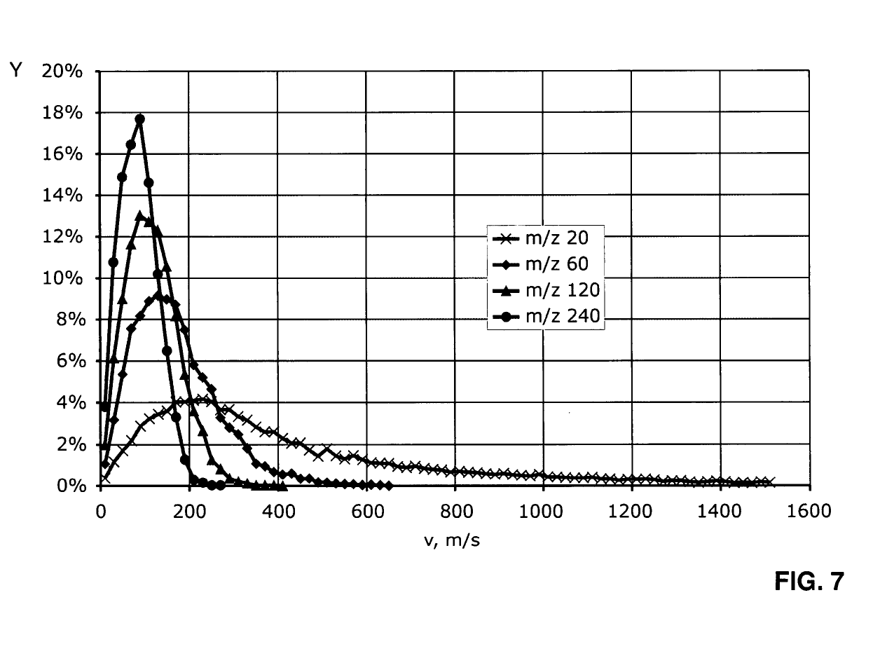

FIGS. 6 and 7 illustrate the calculated axial and radial ion velocity distribution, respectively, of the ions at the exit of the ion source, after additional acceleration by 10 Volts, for a variety of m/z ratios ranging from 20 to 240 amu. Table 2 provides selected numerical results.

TABLE 2
Simulated characteristics of ion beams at different m/z values.

| | Ion mass-to-charge ratio (m/z) | | | |
|---|---|---|---|---|
| | 20 | 60 | 120 | 240 |
| Transmission efficiency | 89.1% | 98.9% | 99.5% | 97.1% |
| Axial velocity (m/s) | 9475 | 5475 | 3870 | 2325 |
| Energy (eV) | 9.37 | 9.39 | 9.38 | 9.30 |
| Axial velocity spread | 216 | 93 | 61 | 73 |
| (m/s) | | | | |
| Temperature (K) | 57 | 31.5 | 27 | 77 |
| Radial velocity (m/s) | 220 | 140 | 115 | 85 |
| Energy (eV) | 5.1 | 6.1 | 6.9 | 9.0 |
| Radial velocity spread | 182 | 104 | 75 | 55 |
| (m/s) | | | | |
| Temperature (K) | 40.1 | 39.3 | 40.9 | 47.3 |
| Beam radius (mm @ | 0.82 | 0.65 | 0.65 | 0.65 |
| 90%) | | | | |
| Emittance (π mm mrad) | 14.4 | 12.5 | 11.8 | 14.4 |
| Normalized emittance | 41.2 | 36.1 | 38.2 | 43.8 |
| (π mm mrad eV^{1/2}) | | | | |

These results show that the ions leave the source with a small initial energy spread in the range below 0.2 eV, depending on m/z ratio, and with high efficiency. The relative energy spread may be further reduced in the subsequent ion optics, as soon as additional acceleration is applied. A potential of only 10 Volts is sufficient to reduce the difference in kinetic energies for different m/z values to below 1%. Higher voltages will reduce this difference even further. This characteristic is especially useful for ion beams that contain a wide range of m/z, like in mass spectrometry, but also in ion deposition experiments, when different materials shall be deposited, where specific re-tuning of the ion optics can be avoided.

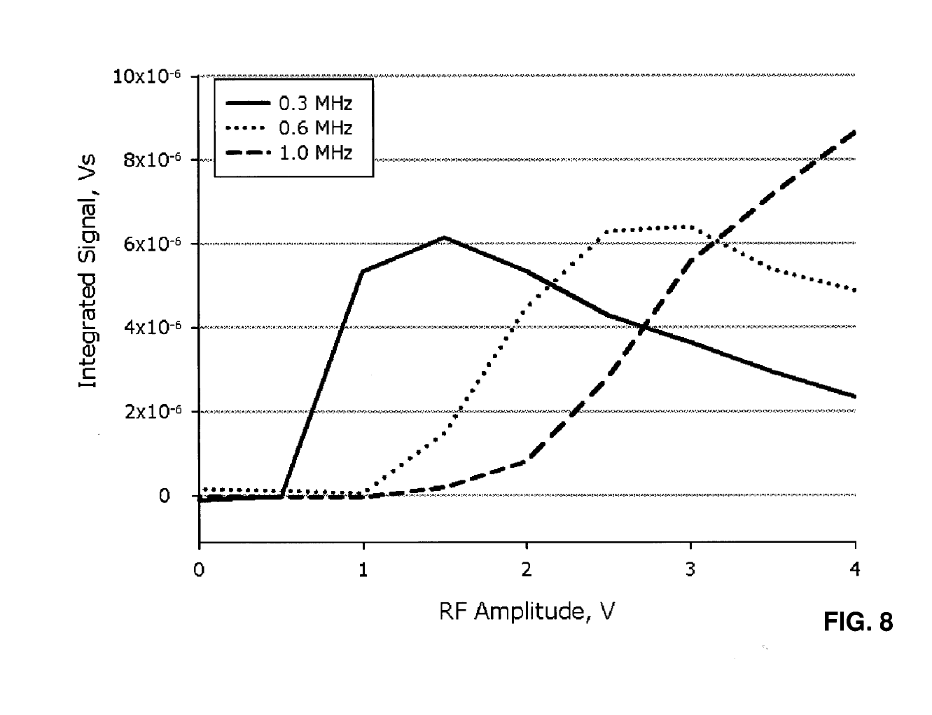

A proof of concept of the focusing properties of the proposed ion funnel arrangement is shown in FIG. 8. Here, ions were generated by high intensity irradiation of a pulsed 532 nm laser (4 mJ incident energy within a spot of 250 μm) from a flat aluminum surface. The ions were then extracted via the described nozzle into the described ion funnel at a gas flow rate of 97 ml/min of He gas and at a pressure in the expansion chamber of 1 mbar, with a potential offset of all funnel electrodes of 2 V. The ions were subsequently detected on an electrode downstream the aperture, following the ion funnel arrangement. Ion detection was preformed by conversion of the current delivered to the electrode into a voltage over a 1 MΩ resistor of an oscilloscope. This way of measuring however does not allow discriminating between ionic and electronic current, which is apparent in the negative offset of the voltages for low RF amplitudes, caused by stray electrons reaching the electrode, while ions are effectively not reaching the funnel exit. Increasing RF amplitude leads to an increasing positive current recorded at the electrode, whose maximum also depends on the RF frequency applied. Higher transmission for the low-m/z ²⁷Al⁺ ions can be achieved by increasing the RF amplitude and frequency, in accordance with theoretically expected behavior.

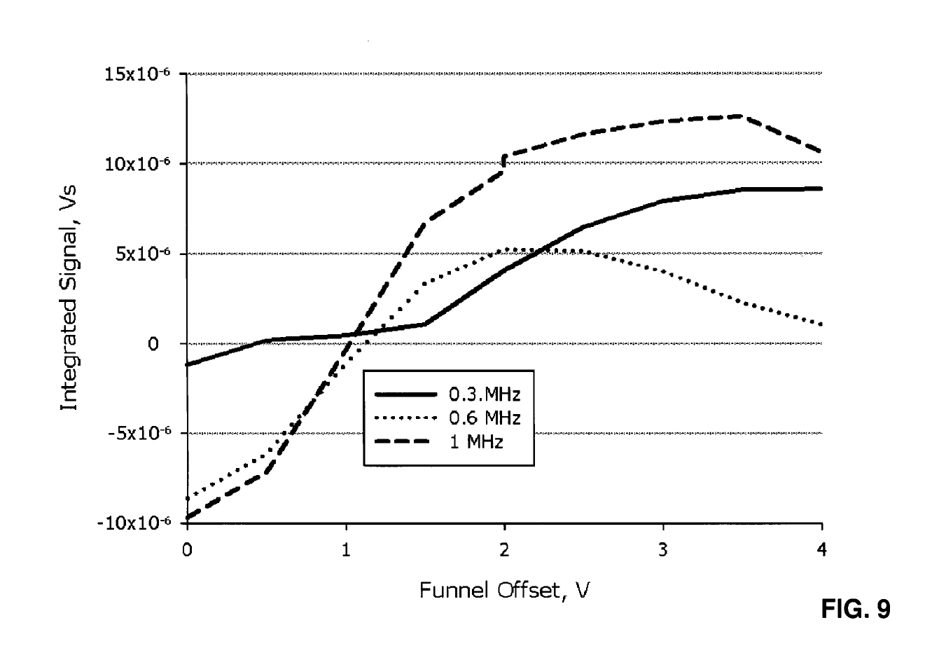

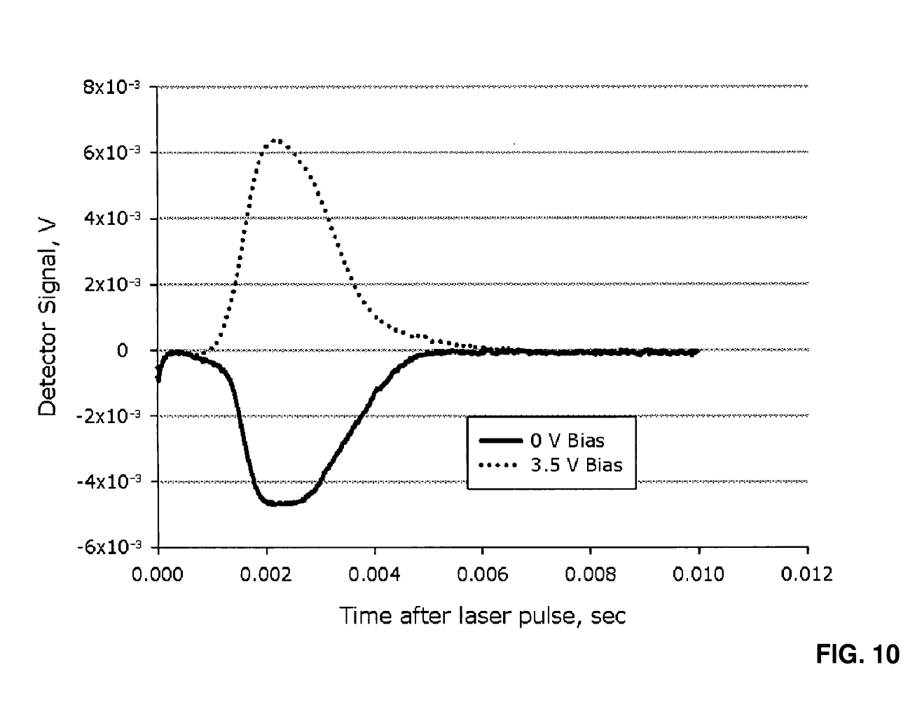

The influence of concomitant electrons is especially prominent when varying the potential offset of all ion funnel electrodes in parallel (FIGS. 9 and 10). At a potential offset below approximately 1 V, the current recorded is dominated by electrons, indicating that ions are not effectively transferred to the electrode downstream the funnel exit. More positive bias leads to positive currents recorded due to increasingly greater discrimination between ions and electrons.

To summarize, the present invention provides an apparatus that contains an RF-only ion funnel device, used to confine ions close to its axis. The invention utilizes ion cooling by collisions with an inert buffer gas, e.g. helium or argon. In specific cases, a reactive gas may be mixed to the buffer gas to initiate specific ion molecule reactions. Ions enter the funnel region, after generation by laser ablation or desorption and ionization, through a specially designed nozzle. The laser-generated ions are transported into the funnel region by means of a buffer gas or gas mixture that also serves to confine the expansion of the ion cloud after ablation. The gas dynamics between the ablation site and the transfer nozzle allow for a high collection efficiency of the ions into the funnel region while the ion funnel serves to enable an efficient pumping of the buffer gas before the high-vacuum region downstream, holding further beam manipulating devices such as ion optics. The composition of the ion beam is primarily determined by the composition of the target ablated. When reactive gases are mixed with the buffer gas, however, also reaction products may occur or ions may be specifically removed from the ion beam. The ions exit the funnel through an exit aperture forming the end of the ion funnel region and enter the high vacuum with a very narrow energy distribution, which allows for high quality imaging of the ion beam towards downstream apertures or surfaces. Laser ablation is carried out using a pulsed laser source whose light is focused onto the substrate to ensure efficient removal and ionization of the material. The laser is targeted through the exit aperture in the ion funnel endplate and the nozzle onto the target, which avoids complicated mechanical installation that would occur when the laser would be directed to the target at an angle. Laser ablation for ion generation allows producing ions from practically any solid material at high yield using a simple experimental setup.

By the present invention, a very compact device can be obtained for the formation of a high intensity ion beam with low emittance. There is no need for high voltage acceleration of the ion beam. Since the ions are transported axially through the ion funnel by the buffer gas flow, the need for a complicated DC feed to the electrodes of the ion funnel is obviated, simplifying the construction dramatically. This should allow the construction of significantly smaller ion sources. Additionally, operating the ion source at moderate pressure reduces the pump speed requirements as the ion source does not need to operate at extremely low pressures. Ion generation by laser ablation or desorption, including MALDI, allows to produce elemental and molecular ions from virtually any solid material. The composition of the ion beam thus depends merely on the purity of the material ablated and the ablation conditions like energy density, wavelength and pulse duration.

Applications range from mass spectrometry to various micro- and nanoelectronic technologies such as ion beam lithography for manufacturing nm-scaled electronic circuits, for example.

In particular, if used as an ion source for mass spectrometry, the source may be employed for the direct analysis of solids by laser ablation. Many applications in geological, materials science and other fields of research and product control require rapid and sensitive determination of the chemical composition. The ion source proposed here can be used to directly probe these materials in a spatial scale of several 10 to 100 μm. The high efficiency of the entire setup will make trace and ultra trace determinations possible. Depending on the laser parameters used, the configuration may even allow to switch between modes used for characterization of the elemental content and molecular species (i.e. similar to matrix assisted laser desorption and ionization—MALDI).

The ion source may also be used as an ion source for different focused ion beam (FIB) techniques, which have become widespread in various micro- and nanoelectronic technologies. FIBs can precisely remove and deposit materials on a substrate with nanometer spatial resolution. At the present time the FIB systems are an indispensable part of the fabrication and development processes in the integrated circuits (IC) industry for lithographic mask repair, failure analysis even in the 3rd dimension (transmission electron microscopy sample preparation) and modification of actual ICs. In a maskless process the FIB allows the fabrication of 3D nano-structures by direct deposition and chemical assisted deposition, or nano-milling by sputtering and selective dry etching in reactive gas atmospheres. Especially mask-free lithography requires sources of low emittance which can be focused to the respective diameters at the surface of a substrate with high ion currents to reduce the processing time. The presently proposed source may increase the flexibility in these applications because the ion energies can be varied over a greater range without compromising the spatial resolution dramatically.

### LIST OF REFERENCE SIGNS

10 sample chamber
11 target holder
12 ablation site
13 nozzle
20 expansion chamber
21 front plate
22 housing
23 ion funnel
24a, 24b, 24a′, 24b′supporting rod
25, 25′electrode
25a, 25b wing
26 aperture
27 spacer
30 high-vacuum chamber
31, 32, 33, 34 ion optics
35, 36 housing
37 window
38 end plate
39 exit aperture
41 laser
42 laser beam
43 focusing lens
50 RF source
v velocity
p pressure
Z axial position
r radial position
E, E′electrode axis
L longitudinal axis
Y yield
m/z mass/charge ratio
S target
N nozzle
a-h position

1. An ion source comprising:
a nozzle delimiting a nozzle aperture, the nozzle defining a longitudinal axis;
an ion funnel positioned downstream of said nozzle aperture and arranged coaxially with said nozzle aperture on said longitudinal axis;
a target holder for receiving a target having a target surface; and
a laser source for generating an ablation laser beam;
wherein said target holder and said laser source are arranged in a manner such that said laser beam impinges upon the target surface of a target received by the target holder at an ablation site located upstream of said nozzle aperture at a distance of less than 10 mm from said nozzle aperture.

2. The ion source of claim 1, wherein the nozzle is a converging-diverging nozzle operable at supersonic conditions.

3. The ion source of claim 1, wherein said laser source is arranged to guide said ablation laser beam to said ablation site substantially along said longitudinal axis.

4. The ion source of claim 3, wherein said laser source is arranged to guide said ablation laser beam to said ablation site through said nozzle aperture.

5. The ion source of claim 4, wherein said laser source is arranged to guide said ablation laser beam to said ablation site through the ion funnel along the longitudinal axis.

6. The ion source of claim 5, wherein the ion source comprises ion optical components downstream of the ion funnel to deflect an ion beam
generated by the ion source in a direction that is angled to the longitudinal axis.

7. The ion source of claim 1, further comprising:
a sample chamber adapted to receive the buffer gas at a first pressure; and an expansion chamber adapted to be pumped to a second pressure substantially lower than said first pressure,
wherein the nozzle aperture connects said sample chamber and said expansion chamber so as to allow a flow of said buffer gas from said sample chamber to said expansion chamber,
wherein the ion funnel is disposed in the expansion chamber, and wherein the ablation site is disposed in the sample chamber.

8. The ion source of claim 7, further comprising: a high-vacuum chamber adapted to be maintained at a third pressure substantially lower than said second pressure; and
an end plate having an exit aperture aligned coaxially with said nozzle aperture and said ion funnel, the exit aperture connecting said expansion chamber and said high-vacuum chamber.

9. The ion source of claim 8, wherein said high-vacuum chamber comprises ion optical components for deflecting an ion beam exiting said exit aperture into a direction that is transverse to said longitudinal axis.

10. The ion source of claim 9, wherein said laser source is arranged to couple the laser beam into the high-vacuum chamber through a window arranged in a wall of the high-vacuum chamber on the longitudinal axis downstream of the exit aperture of the ion funnel, and to guide said ablation laser beam to said ablation site through the exit aperture, the ion funnel, and the nozzle aperture along the longitudinal axis.

11. An ion funnel, comprising:
a plurality of electrically conducting electrodes spaced along a longitudinal axis, each electrode having an aperture, the apertures being coaxially arranged on the longitudinal axis,
wherein
said electrodes are shaped as substantially flat, elongate plates, each electrode defines an electrode axis perpendicular to the longitudinal axis, and the electrode axes of adjacent electrodes have different orientations.

12. The ion funnel of claim 11,
wherein a first group of said electrodes are arranged such that their electrode axes have a first orientation,
wherein a second group of said electrodes are arranged such that their electrode axes have a second orientation different from the first orientation, and wherein the first and second groups are arranged such that electrodes belonging to the first group and electrodes belonging to the second group alternate along the longitudinal axis.

13. The ion funnel of claim 12, wherein the electrodes of the first group are supported by at least one first supporting rod, and wherein the electrodes of the second group are supported by at least one second supporting rod, the first and second supporting rods extending parallel to the longitudinal axis at different angular positions around the longitudinal axis.

14. The ion funnel of claim 12, wherein the electrodes of the first group are electrically connected to each other by one or more first electrically conducting elements, and wherein the electrodes of the second group are electrically connected to each other by one or more second electrically conducting elements.

15. The ion funnel of claim 14, further comprising an RF voltage source operable to provide a first RF voltage to the first group of electrodes and a second RF voltage to the second group of electrodes, the second RF voltage having identical frequency and amplitude as the first RF voltage, but being out of phase with the first RF voltage.

16. The ion source of claim 1, comprising an ion funnel that comprises:
a plurality of electrically conducting electrodes spaced along a longitudinal axis, each electrode having an aperture, the apertures being coaxially arranged on the longitudinal axis,
wherein said electrodes are shaped as substantially flat, elongate plates, each electrode defines an electrode axis perpendicular to the longitudinal axis, and the electrode axes of adjacent electrodes have different orientations.

17. A method of producing an ion beam, comprising:
ablating ions from a target surface at an ablation site by an ablation laser beam;
transporting said ions by a stream of buffer gas through a nozzle defining a nozzle aperture; and
transporting said ions, together with said buffer gas, into an ion funnel located downstream of said nozzle and arranged coaxially with said nozzle aperture on a longitudinal axis;
wherein said ablation site is located upstream of said nozzle aperture, at a distance of less than 10 mm from said nozzle aperture.

18. The method of claim 17, wherein the ablation laser beam is guided to said beam spot location substantially along said longitudinal axis.

19. The method of claim 18, wherein the ablation laser beam is guided to said beam spot location through said nozzle aperture.
